(19) United States
(12) Patent Application Publication
(10) Pub. No.: US 2019/0061419 A1
(43) Pub. Date: Feb. 28, 2019

(54) EASY-RECOGNIZABLE BICYCLE WHEEL AND BICYCLE BODY

(71) Applicant: Haeng Jun Oh, Daejeon (KR)

(72) Inventor: Haeng Jun Oh, Daejeon (KR)

(21) Appl. No.: 15/968,803

(22) Filed: May 2, 2018

(30) Foreign Application Priority Data
Aug. 28, 2017 (KR) 10-2017-0108798

(51) Int. Cl. B60B 1/00; B60B 1/02; B60B 21/12; B60C 13/00

(52) U.S. Cl. CPC B60B 1/003; B60B 1/02; B60B 21/12; B60C 2200/12; B60B 2900/571; B60B 2900/572; B60C 13/001

(57) ABSTRACT

Provided are an easy-recognizable bicycle wheel and a bicycle body by forming identification bands on bicycle tires or on rims and bicycle spokes with protruded therefrom or recessed thereinto and with a single color or various colors and in varied sectional shapes by the selection and preference of bicycle users, thereby to provide safety protection to be easily and instantly recognizable from far distanced away as well as during daytime and night time, and provide excellent visual outlook in accordance with characteristics of users.

### CROSS-REFERENCE TO RELATED APPLICATION

This application claims priority under 35 U.S.C. § 119 to Korean Patent Application No. 10-2017-0108798 filed on Aug. 28, 2017, the disclosure of which is hereby incorporated by reference in its entirety.

### BACKGROUND

### 1. Field of Invention

Embodiments of the present invention relate to an easy-recognizable bicycle wheel and a bicycle body, and more particularly, to a bicycle wheel for allowing easily recognizable during daytime and night and from far distanced away and providing excellent visual outlook in accordance with various fashion of a user, and a bicycle body having the same.

### 2. Description of Related Art

The risks of bicycle accidents have been increasing because the distribution of bike-only lanes is not realized compared with the increased supply of bicycles and most of bicycle riders have no other paths to ride but automobile paths.

Further, when a bike user rides on dark paths at night, it is hard for automobile drivers to see and recognize the bike rider, and particularly, when children who are immature and have little judgment about the surrounding conditions ride on bicycles, the accident risks by sudden actions are further increasing, so that automobile drivers must see and tell such bicycle riding from even far distanced sight.

However, tools or methods to possibly recognize bicycle on riding at night not on daytime are little, and a small night-glow light reflector which is attached to bike spokes or frame, etc. and shows little luminous light by reflection on light receiving does such a function but is not effective sufficiently.

The small night-glow light reflector little function during daytime, and during night time, it can raise reflection only by the light input from outside, it is very poor in functions to provide telling and allow to recognize the riding bicycle to a third person, so that such bicycle riders are exposed to safety accidents all the time.

Therefore, it is highly required to develop and produce bicycle wheels to provide excellency in recognizing at dark night, and to show diverse and highly charming appearance, too.

### PRIOR ART DOCUMENT

(patent 1) Korean Patent Publication 10-2017-0064446 (Jun. 9, 2017)

### SUMMARY

Embodiments of the present invention are directed to provide an easy-recognizable bicycle wheel for allowing easily recognizable even from far distanced away as well as during daytime and night time, and providing excellent visual outlook in accordance with various characteristics of a user, and a bicycle body having the same, and more precisely, an easy-recognizable bicycle wheel and a bicycle body by forming an identification band on a bicycle tire, a rim, or bicycle spokes by using luminous or night glow paint on one side or both sides of a wheel with its number, paint width, or sectional shape varied in accordance with various embodiments of the present invention for keeping user's characteristics while providing difference from other bicycles, thereby to be easily and instantly recognizable at night as well as excellent and varied outlook of the bicycle.

Also, the present invention is directed to provide a bicycle wheel which functions to guarantee safe riding of bicycle users during night time by allowing it to be easily and instantly found and tell the bike on riding, and a bicycle body having the same.

In accordance with an aspect of the present invention, the easy-recognizable bicycle wheel which may include a rim having spokes connected thereto, a tire integrally formed with and covering the external circumference of the rim, an identification band integrally formed with the tire and on the both sides of the tire to form a concentric circle there with, and formed of luminous or night glow paints which are predetermined colors and recognizable during daytime and night, thereby to be easily and instantly recognized to tell the location and the movement of the bicycle during daytime and night and even from far distance, and formed to have excellent exterior appearance, and the identification band may be formed by forming filling grooves, which are predetermined and sectional shaped, on one side or both sides of the tire, and filling the grooves with paints, or by forming with externally protruded from both sides of the tire in predetermined sectional shape, so as to be integral with the tire.

The identification band may be formed such that a plurality of the identification bands are sequentially aligned while having an equal width and distanced apart in predetermined gap from each other, or formed such that a single band may be formed in a predetermined width d.

The identification band may be formed such that a single band is formed in one ring or a plurality of arcs are aligned with a predetermined distance apart from each other to form a circle.

The identification band may be formed of one among triangle, half-circle, square, and polygon, in its sectional shape.

Further, an additional identification band may be formed on the spokes or on one side or both sides of the rim which is not contacted with a bicycle brake to be used to stop a bicycle, so as to be ring-shaped while forming concentric circle with a wheel.

Therefore, the bike riding at night as well as daytime and even from a far distance can be instantly and well recognized according to the present invention.

Further, it is possible to form the identification bands on the tires of a bicycle, the rim and the spokes, and therefore, provide various manufacturing shapes and features according to characteristics of bike riders.

Further, the bicycle wheel and the bicycle body with the identification bands of the present invention can be easily made and easily employed in the bicycle manufacturing.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The foregoing and other features and advantages of the present inventions will be apparent from the more particular description of preferred embodiments of the present inventions, as illustrated in the accompanying drawings in which like reference characters refer to the same parts throughout the different views. The drawings are not necessarily to scale, emphasis instead being placed upon illustrating the principles of the present inventions. In the drawings:

FIG. 1 shows an easy-recognizable bicycle wheel and a bicycle body having the same according to an embodiment of the present invention; and

FIGS. 2A, 2B, 2C, 2D and 2E show an identification band of an easy-recognizable bicycle wheel and a bicycle body according to various embodiments of the present invention.

### DETAILED DESCRIPTION OF THE EMBODIMENTS

Since exemplary embodiments of the present invention are provided only for structural and functional descriptions of the present invention, the present invention should not be construed as limited to the embodiments set forth herein. Thus, it will be clearly understood by those skilled in the art that the exemplary embodiments of the present invention may be embodied in different forms and include equivalents that can realize the spirit of the present invention. It should be understood, however, that it is not intended to limit the present invention to the particular forms disclosed, but on the contrary, the present invention is to cover all modifications, equivalents, and alternatives falling within the spirit and scope of the present invention as defined by the appended claims.

It will be understood that, although the terms first, second, etc. may be used herein to describe various elements, components and/or sections, these elements, components, and/or sections should not be limited by these terms. These terms are only used to distinguish one element, component or section from another ones. Thus, a first element, component or part discussed below could be termed a second element, component or part without departing from the teachings of the present invention.

It will be understood that when an element or part is referred to as being “connected to” or “coupled to” another element or part, it can be directly connected or coupled to the other element or part or intervening elements or parts may be present. In contrast, when an element is referred to as being “directly connected to” or “directly coupled to” another element or part, there are no intervening elements or parts present. Meanwhile, spatially relative terms, such as “between” and “directly between” or “adjacent to” and “directly adjacent to” and the like, which are used herein for ease of description to describe one element or feature's relationship to another element(s) or feature(s) as illustrated in the figures, should be interpreted similarly.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. Terms indicating directions of apparatuses or elements (such as “front”, “back”, “up”, “down”, “top”, “bottom”, “left”, “right”, and “lateral”) are used to simplify description of the invention and do not represent nor mean that the apparatuses or elements have specific directions. It will be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Unless expressly defined in a specific order herein, respective steps described in the present invention may be performed otherwise. That is, the respective steps may be performed in a specified order, substantially at the same time, or in reverse order.

The present invention will now be described more fully hereinafter with reference to the accompanying drawings, in which exemplary embodiments of the present invention are shown.

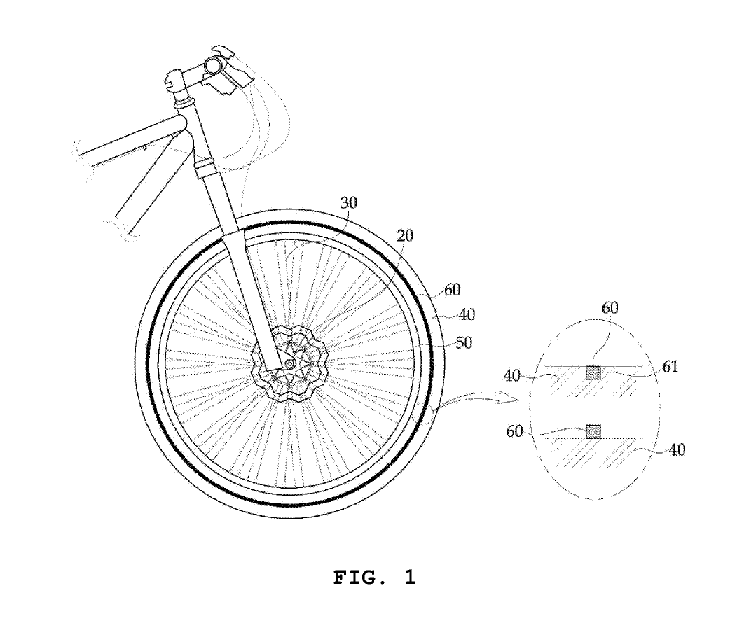

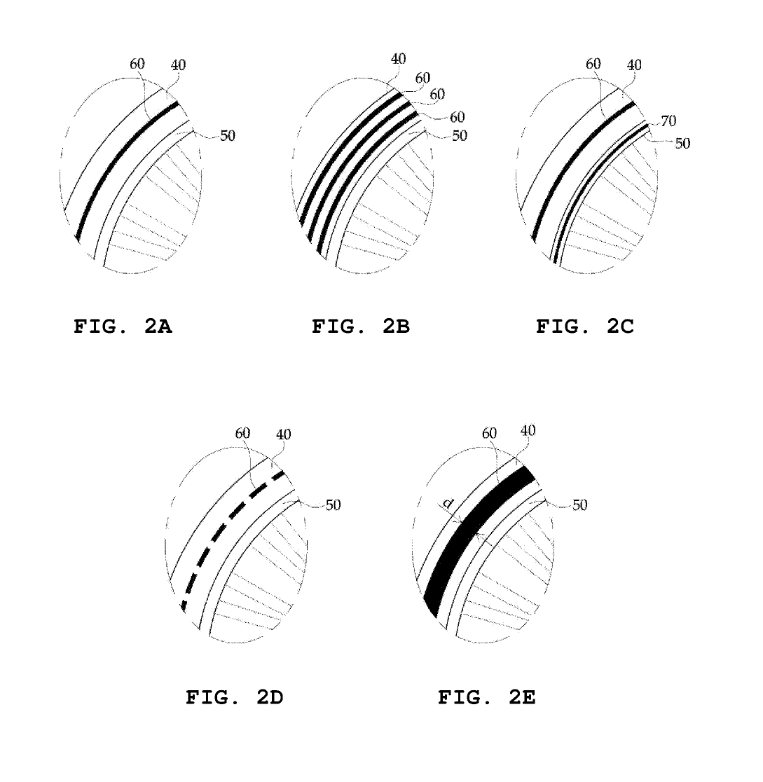

Hereinafter, an easy-recognizable bicycle wheel and a bicycle body according to one embodiment of the present invention will now be described in more detail with reference to FIGS. 1 and 2.

The easy-recognizable bicycle wheel and the bicycle body according to the present invention include a rim 50, a tire 40, and an identification band 60.

The rim 50 is provided in a normal bicycle, and a plurality of spokes 30 are connected with the rim 50 in such a manner that one end of each spoke is connected to a wheel hub 20, which is located at the center of the bicycle wheel 10 (hereinafter, referred to as ‘wheel’ for convenience of description), and the other ends of the spokes 30 are radially connected to the rim 50.

The rim 50 also functions to stop the rotation of the wheel or reduce the speed of the bicycle, while both sides or one side of the outer circumference of the rim 50 contact with a brake pad.

The tire 40 is provided to cover the outer circumference of the circular-shaped rim 50 described as above to be integral there with, so that the tire 40 contacts directly with the ground when the bicycle is driven.

The rim 50 has a protrusion portion from both sides of the tire 40 to be identified from the outside. Meanwhile, the brake pad is partially contacted with where the tire 40 is not formed so as to provide a brake function. The rim 50 and the tire 40 described above are widely known structure of the bicycle.

The identification band 60 is formed on the wheel 10 of the bicycle of the present invention, and by the identification band 60, the location and the driving path of the bicycle can be easily found and well recognized during daytime and even at night, and a bicycle driver can express his or her own independent styles and characteristics by the identification band 60.

For this purpose, the identification band 60 can be formed on one side or both sides of the outer circumference of the tire 40, and form a concentric circle with the tire 40 or the wheel 10 at the one side or both sides of the tire 40, and is integrally formed with the tire 40 in circular shape.

Further, the identification band 60 can be formed with various forms in accordance with embodiments of the present invention, and can be made by forming filling grooves 61 in the tire 40 in dented and with predetermined sectional shape (any one sectional shape among triangle, half-circle, quadrangle, or polygon), and filling the filling groove 61 with identifiable and predetermined luminous or night glow paint so as to be integral with the tire 40.

In other way, the identification band 60 can be formed on the tire 40 in a ring shape (or circular shape) with externally protruded there from in predetermined sectional shape, without forming the filling groove 61, so as to be integral with the tire 40.

Related with the size of the recess or protrusion of such an identification band, it can be varied according to various embodiments by a user, but in this embodiment of the present invention here, the height of the protruded size or the depth of the recessed size is 0.5˜2 mm, and their width is 1˜3 mm.

Of course, it is natural that the identification band 60 is integrally made with the tire 40 according to various embodiments by a user or the manufacturing methods thereby (electro-deposition, coating, and so on).

In short, the identification band 60 is formed at one side or both sides of the tire 40, to be recessed into the tire 40 not to be protruded, or on the contrary, may be formed with externally protruded from the tire 40.

Further, the identification band 60 may have various colors according to selection of a user, and a plurality of the identification bands 60 with all circular shape and having the same width, may be sequentially aligned on the side surface of the tire 40 in a predetermined distance apart from each other (FIG. 2B), or only one single identification band 60 can be provided with its width predetermined as ‘d’ while the plurality of the identification bands 60 having the same width are sequentially aligned as above. (FIG. 2E)

The identification band 60 can be made such that a plurality of arc-shaped bands are aligned in one line to form a circle with each arc band distanced with a predetermined gap with each other unlike the above case in that a single band (FIGS. 2A, 2B, 2C and 2E) or plural bands form ring-shaped circle or circles together as the identification band 60. (FIG. 2D)

Further, the identification band 60 is formed on one side or both sides of the tire 40 as the above, and additional identification band 70 may be further provided in another embodiment of the present invention. (FIG. 2C)

The additional identification band 70 may be formed on the plural and radial spokes 30, or on one surface or either one of both sides of the rim 50 which is not contacted with the bicycle brake used to stop the wheel, in a ring shape to form concentric circles with the wheel, and formed by luminous or night glow paint which is with predetermined color and easily recognizable during daytime and night.

In the case of the wheel spokes 30, the additional identification band 70 can be formed on the plural spokes 30 in a ring shape by painting paints with various methods such as coating, etc. or by painting luminous or night glow paint on the entire wheel spokes 30, or on only some portion of the plurality of the spokes 30 selected by a user.

In the case of the rim 50, like the identification band 60 formed on the tire 40, the additional identification band 70 can be formed by forming a recess on one side or both sides of the rim 50 in predetermined and sectional shape, and by filling the recess with luminous or night glow paint, and made to be a ring or a plurality of arcs which are spaced from each other and aligned to be a ring shape, thereby to be integral with the rim 50, or by forming luminous or night glow paint on the external circumference of the rim 50 with protruded there from in predetermined sectional shape to be a ring, or for a plurality of arcs to be aligned to be a ring shape. Here, the additional identification band 70 formed on the rim 50 should be formed not to contact with the brake pad.

Further, the identification band 60 and the additional identification band 70 of the present invention may be formed on the front wheel or the back wheel of a bicycle, or on both the front wheel and the back wheel of a bicycle.

Further, the identification band 60 and the additional identification band 70 may be formed on the entire bicycle body or a portion of the bicycle body selected by a user according to various embodiments of the present invention as well as on the bicycle wheels.

The foregoing is illustrative of embodiments and is not to be construed as limiting thereof. Although a few embodiments have been described, those skilled in the art will readily appreciate that many modifications are possible without materially departing from the novel teachings and advantages. Accordingly, all such modifications are intended to be included within the scope of this present invention as defined in the claims. In the claims, means-plus-function clauses are intended to cover the structures described herein as performing the recited function, and not only structural equivalents but also equivalent structures.

What is claimed is:

1. An easy-recognizable bicycle wheel and a bicycle body having the same, comprising:
a rim (50) having spokes (30) connected there with;
a tire (40) integrally formed with and covering the external circumference of the rim (50);
an identification band (60) integrally formed with the tire (40) and on the both sides of the tire (40) to form a concentric circle there with, and formed of luminous or night glow paints which are predetermined colors and recognizable during daytime and night; and
an additional identification band (70) formed on one surface or either one of the both sides of the rim (50), on which the spokes (30) and a bike brake used to stop bike wheels are not contacted, wherein
the identification band (60) allows the bicycle on riding to be easily and instantly recognized to tell the location and the movement of the bicycle during daytime and night time and even from a far distance, and is formed to have excellent exterior appearance,
the identification band (60) is formed by forming filling grooves (61), which are predetermined and sectional shaped, on one side or both sides of the tire (40), and filling the grooves (61) with paints, or by forming with externally protruded from both sides of the tire (40) in predetermined sectional shape, so as to be integral with the tire (40),
the identification band (60) is formed such that a plurality of the identification bands (60) are sequentially aligned while having an equal width and distanced apart in predetermined gap from each other, or formed such that a single band is formed in a predetermined width d,
the identification band (60) is formed such that a single band is formed in one ring or a plurality of arcs are aligned with a predetermined distance apart from each other to form a circle and the sectional shape is one among triangle, half-circle, square, and polygon,
in the spokes (30), an additional identification band (70) is formed in a ring shape on a plurality of the spokes (30) by coating plating, or formed on the entire spokes (30) by painting luminous or night glow paints, or painting on only a portion of the spokes (30) selected by a user among the plurality of the spokes (30),
in the rim (50), like the identification band (60) formed on the tire (40), the additional identification band (70) is formed by forming a recess on one side or both sides of the rim (50) in predetermined and sectional shape, and filling the recess with luminous or night glow paint so as to be a ring, or forming recesses in a plurality of arcs spaced from each other and aligned to be a ring shape, or by forming luminous or night glow paint on the external circumference of the rim (50) to be protruded there from in predetermined sectional shape, so as to be a ring, or a plurality of arcs aligned to be a ring, and
the identification band (60) and the additional identification band (70) are formed on only the front bicycle wheel or the back wheel, or on the both front and back wheels.
